(19) United States
(12) Patent Application Publication
(10) Pub. No.: US 2009/0211214 A1
(43) Pub. Date: Aug. 27, 2009

(54) Filter plate for a particle filter

(75) Inventors: Hubert Felder, Holzwickede (DE); Carsten Kohberg, Dortmund (DE)

Correspondence Address: CROWELL & MORING LLP;INTELLECTUAL PROPERTY GROUP, P.O. BOX 14300, WASHINGTON, DC, 20044-4300, US

(73) Assignee: Purem Abgassysteme GMBH & Co. KG, Unna (DE)

(21) Appl. No.: 11/659,195

(22) PCT Filed: Aug. 3, 2005
(86) PCT No.: PCT/EP05/08398

§ 371 Date: Dec. 8, 2008

(30) Foreign Application Priority Data
Aug. 4, 2004 (DE) 10 2004 037 706.5

(51) Int. Cl. B01D 46/10; F01N 3/022

(52) U.S. Cl. 55/485; 55/523

(57) ABSTRACT

The invention relates to a filter plate for a particulate filter which serves to separate particulates out of an exhaust gas flow of an internal combustion engine.

A filter plate for a particulate filter which serves to separate particulates out of an exhaust gas flow of an internal combustion engine is proposed, which filter plate is composed of a substrate material, which is permeable to gas and is coated with a sintered metal powder, and has a surface region which extends substantially in a plane.

It is provided according to the invention that the surface region (2) is provided with alternating linear depressions (3) and elevations (4), with a section (2a) of the planar surface region (2) remaining at least between two successive depressions (3) or elevations (4).

The filter plate is suitable for the construction of a particulate filter which serves to separate particulates out of an exhaust gas flow of an internal combustion engine.

The invention relates to a filter plate for a particulate filter which serves to separate particulates out of an exhaust gas flow of an internal combustion engine, as per the type defined in more detail in the preamble of claim 1. The invention also relates to a particulate filter which serves to separate particulates out of an exhaust gas flow of an internal combustion engine.

A filter for separating impurities out of exhaust gases is known from DE 42 34 930 A1, which filter has a filter body with a plurality of filter plates which are composed of sintered metal powder and are arranged so as to form a plurality of adjacent flow ducts. The individual filter plates are of corrugated shape and are traversed by flow in the longitudinal direction or axial direction. Said corrugated shape of the filter plates leads to the formation of longitudinal ducts which are each delimited from one another and become very quickly clogged with ash and can therefore adversely affect the performance of the filter. In addition, the ducts which are shaped in this way result in a highly directed flow which prevents a distribution over the plane of the filter plates and thus leads to an increased exhaust gas back pressure. A further disadvantage of the known filter plates is their low stiffness, which partially considerably impedes the handling thereof and can adversely affect their durability.

A further particulate filter is described in WO 02/102494 A1. Here, a plurality of star-shaped filter pockets are arranged around the periphery of a central bore, which filter pockets have a triangular cross section and into which filter pockets a distancing element is inserted, which is intended to prevent deformation of the filter pockets under the exhaust gas pressure. Said distancing element, also referred to as a spacer, is however an additional component which constitutes additional expenditure in the production of the particulate filter. In addition, it must be ensured when designing the distancing element that the latter does not impede the exhaust gas flow, as this would cause an increase in the exhaust gas back pressure.

It is an object of the present invention to produce a filter plate for a particulate filter which has a sufficient degree of stiffness and does not deform under the exhaust gas pressure when forming an inflow or outflow duct together with further filter plates. In addition, the shape of the filter plate should provide the least possible resistance to the exhaust gas flow.

Said object is achieved by means of a filter plate having the features of claim 1.

The linear depressions integrated in the filter plate according to the invention serve to improve the stiffness of the individual filter plates, so that the latter can be handled more easily in subsequent machining steps and also have a reduced tendency to deform under pressure. If two filter plates according to the invention are joined together to form an inflow or outflow duct or a filter pocket when constructing a particulate filter, each individual depression or elevation is supported on the depression or elevation of the adjacent filter plate, so that the stiffness of the individual ducts can also be considerably improved. The linear shape of the depressions or elevations ensures here that, even with relatively generous tolerances, the depressions and elevations always come to rest against their respective counterpart at corresponding cross-over points, so as to prevent two adjacent filter plates falling into one another and therefore to ensure a constant spacing of said filter plates and therefore to ensure a throughflow of the exhaust gas. If the conventional tolerances are maintained, it is possible to expect much higher degrees of precision in a filter block composed of a plurality of filter plates according to the invention, which considerably simplifies the production of said filter block.

As a result of the fact that a section of the planar surface region remains at least between two successive depressions or elevations, it is constantly ensured that the exhaust gas flow can be distributed areally over the filter plate and therefore in the inflow and outflow ducts, so that the particulate filter formed by means of the filter plates according to the invention generates a very low exhaust gas back pressure.

In addition, it is advantageously possible to form the linear depressions and elevations according to the invention so as to extend a small distance into the material of the filter plate, with the result that the individual meshes of the substrate material are only lightly loaded and the filter material is not damaged by the shaping process.

If, in an advantageous refinement of the invention, it is provided that the linear depressions and elevations extend in a wave form over the surface region, this ensures both a very high degree of stiffness of the filter plate and also a very effective and uniform flow through a filter pocket formed by said filter plate.

A particularly high number of cross-over points of the depressions or elevations of adjacent filter plates results if the linear depressions and elevations extend continuously over the surface region.

A particulate filter for separating particulates out of an exhaust gas flow of an internal combustion engine having a plurality of filter plates arranged substantially parallel to one another is specified in claim 11.

Further advantageous embodiments and refinements of the invention can be gathered from the remaining subclaims. In the following, exemplary embodiments of the invention are illustrated in principle on the basis of the drawing, in which:

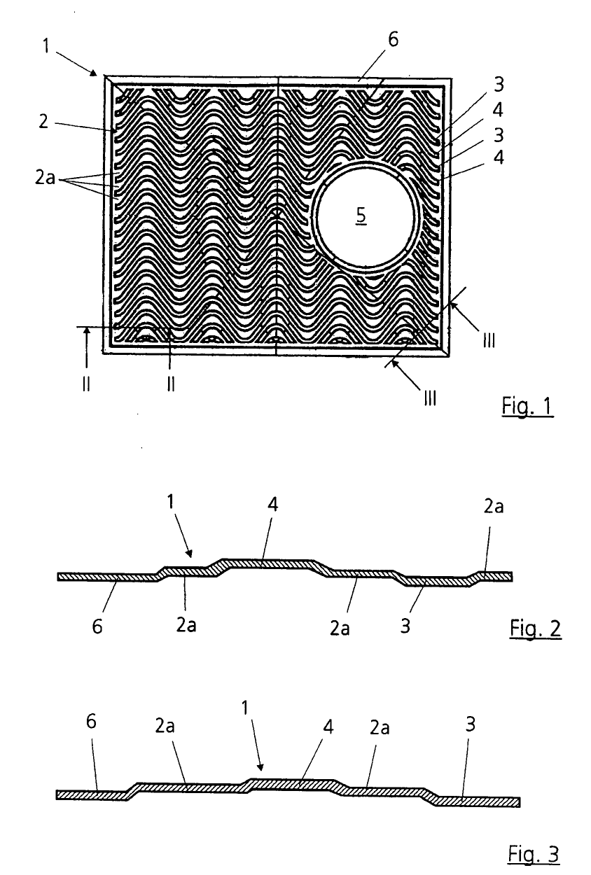

FIG. 1 shows a plan view of a first embodiment of the filter plate according to the invention;

FIG. 2 shows a section as per the line II-II in FIG. 1;

FIG. 3 shows a section as per the line III-III in FIG. 1;

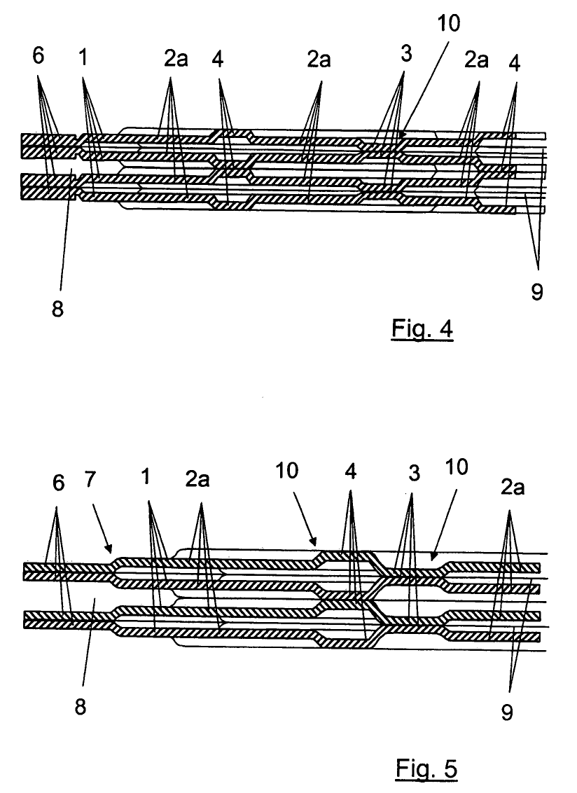

FIG. 4 shows an arrangement of a plurality of filter plates from FIG. 1 to form a filter body;

FIG. 5 shows an arrangement of a plurality of filter plates in an alternative embodiment;

FIG. 6 shows a plan view of a second embodiment of the filter plate according to the invention;

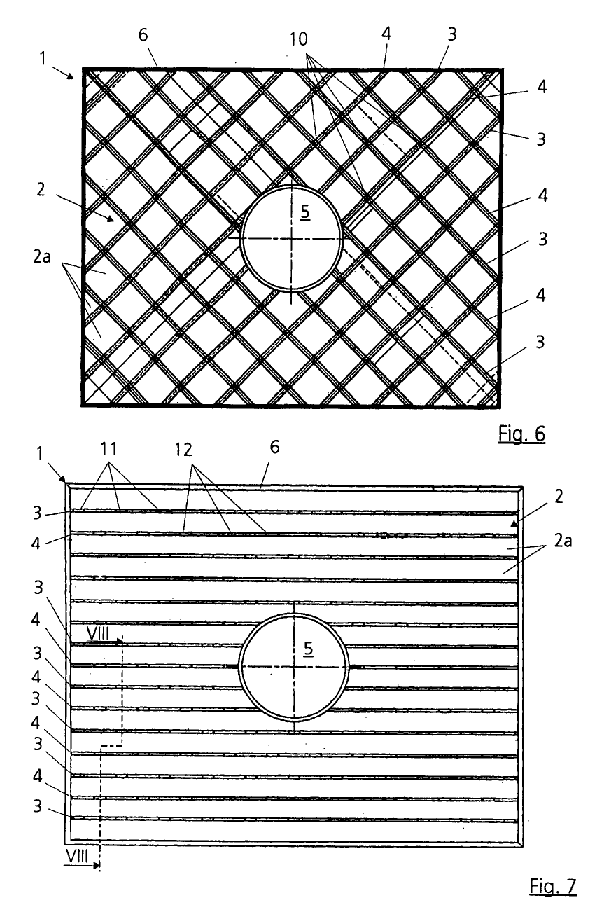

FIG. 7 shows a plan view of a third embodiment of the filter plate according to the invention;

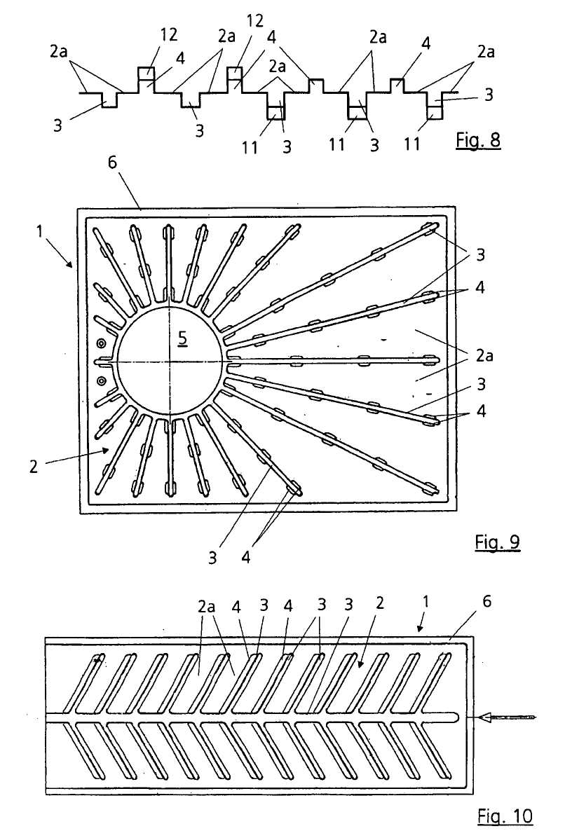

FIG. 8 shows a section as per the line VIII-VIII in FIG. 7;

FIG. 9 shows a plan view of a fourth embodiment of the filter plate according to the invention; and

FIG. 10 shows a plan view of a fifth embodiment of the filter plate according to the invention.

FIG. 1 shows a filter plate 1 which is used to form a particulate filter, not illustrated in its entirety, which serves to separate particulates out of an exhaust gas flow of an internal combustion engine. The location of use, preferably within an exhaust system of the internal combustion engine, and the mode of operation of a particulate filter of said type is described in principle in DE 42 34 930 A1, for which reason this will not be discussed in any more detail in the following.

The filter plate 1 is composed of a substrate material, which is permeable to gas and is coated with a sintered metal powder, and has a surface region 2 which extends substantially in a plane, specifically in the present case the drawing plane. In order to produce a spacing of the filter plates 1 from one another when arranging two such filter plates 1 on top of one another, as illustrated in FIG. 4, the surface region 2 of the filter plate 1 is provided with alternating linear depressions 3 and elevations 4. However, there always remains a section 2a of the planar surface region 2 at least between two successive depressions 3 or elevations 4. In this context, it should be clarified that, depending on how they are viewed, the depressions 3 constitute an elevation 4 on the opposite side of the filter plate 1, and vice versa.

In the embodiment of the filter plate 1 illustrated in FIG. 1, the linear depressions 3 and the linear elevations 4 are designed in a wave form and extend continuously over the entire surface region 2. An exception from this is formed only by a bore 5, through which the exhaust gas flow which flows in over the entire edge 6 of the filter plate 1 is discharged from the filter plate 1. In order to obtain an arrangement of the wave-shaped depressions 3 and elevations 4 which is suitable with regard to strength and a flow-enhancing design for each size of filter plate 1, the amplitude and the pitch of said depressions 3 and elevations 4 can be calculated for example by means of finite element methods (FEM). This of course also applies to the further embodiments described in the following.

The relative arrangement of the depressions 3 and of the elevations 4 to the sections 2a of the planar surface region 2 can be more clearly seen in FIGS. 2 and 3. It can be seen from said figures that the edge 6 lies at the same level as the depressions 3, and that a section 2a of the planar surface region 2 is provided between each depression 3 and the adjacent elevation 4. The same is true in FIG. 3, which shows merely a section through the filter plate 1 at a different point.

FIG. 4 illustrates part of a filter body 7 which is formed by individual filter plates 1 being layered on top of one another in parallel, and together with further known (and therefore not illustrated) components forms the particulate filter. This results in alternating inflow ducts 8 and outflow ducts 9, also referred to as filter pockets, wherein particulates, in particular soot particulates, are separated out of the exhaust gas flow as the latter passes from one of the inflow ducts 8 through the filter plate 1 into one of the outflow ducts 9. In order to allow the exhaust gas flow to flow in between the filter plates 1 and at the same time to allow said exhaust gas to be discharged only through the bore 5, the outflow ducts 9 are connected to one another at the edges 6 of the filter plates 1. Said connection can preferably be provided by means of welding, for example using the TIG welding method as is known per se. The filter plates 1 illustrated in FIG. 4 substantially correspond to those in FIGS. 1, 2 and 3, so that a section 2a of the planar surface region 2 remains between each linear depression 3 and the adjacent linear elevation 4. It can be seen that in each case the elevations 4 of the adjacent filter plates 1 which form the inflow ducts 8 and the depressions 3 of those filter plates 1 which form the outflow ducts 9 are in contact with one another at the cross-over points 10. With regard to a high number of cross-over points 10, it has proven to be particularly suitable if two adjacent filter plates 1 are designed so as to be mirror-symmetrical with respect to one another.

In contrast thereto, it is provided in the filter body 7 as per FIG. 5 that a linear depression 3 directly adjoins a linear elevation 4. In order to nevertheless permit sufficient distribution of the exhaust gas flow over the filter plates 1, a section 2a of the planar surface region 2 adjoins each linear depression 3 and also each linear elevation 4.

FIG. 6 illustrates a second embodiment of the filter plate 1, whose linear depressions 3 and elevations 4 extend diagonally over the surface region 2. The illustration as per FIG. 6 shows two filter plates 1 arranged one on top of the other, so that the cross-over points 10 are illustrated between the depressions 3 of two adjacent filter plates 1 and the elevations 4 of two adjacent filter plates 1. It is of course also possible in the case of two adjacent filter plates 1 that in each case only the depressions 3 or only the elevations 4 cross one another or are in contact with one another.

A further embodiment of the filter plate 1 is illustrated in FIG. 7. Here, the linear depressions 3 and the linear elevations 4 extend over the filter plate 1 in the longitudinal direction parallel to the longitudinal edges 6. In order to prevent flow ducts forming in the filter pockets formed by two such filter plates 1, the linear depressions 3 are provided with a plurality of punctiform depressions 11 and the linear elevations 4 are provided with a plurality of punctiform elevations 12, which then form the respective cross-over points 10 with the adjacent filter plate 1. Here, the depressions 3 or elevations 4 of two filter plates 1 can be placed on one another so as to be parallel or so as to cross over one another. The design of the punctiform depressions 11 and of the punctiform elevations 12 can be more clearly seen in the section as per FIG. 8.

In the embodiment of the filter plate 1 as per FIG. 9, the linear depressions 3 run in the shape of a star in the direction of the bore 5, and circularly around the bore 5. In this way, an enlarged cross section should be provided for discharging the clean air flow flowing through the outflow ducts 9, in order to reduce the exhaust gas back pressure and any turbulence, with the cross section of the inflow ducts 8 being reduced by a certain amount. This means that the depressions 3 are associated with the outflow ducts 9 and constitute corresponding elevations in the inflow ducts 8.

Elevations 4 are provided in each case along the depressions 3 in order to maintain the principle effect of the mutual support of the filter plates 1.

A similar effect with regard to a fast discharge of the exhaust gases out of the outflow ducts 9 is achieved by means of the embodiment of the filter plate 1 illustrated in FIG. 10. Here, the linear depression 3 of the filter plate 1 is in the shape of a fishbone, so that the exhaust gas flow penetrating into the outflow ducts 9 can pass through the individual depressions which form the branches into the central depression, and can be discharged from there. Here, too, the depression 3 is assigned respective elevations 4. Said embodiment is particularly suitable for very long filter plates 1.

1-13. (canceled)

14. A filter plate for a particulate filter that serves to separate particulates out of an exhaust gas flow of an internal combustion engine, the filter plate comprising:
a substrate material, which is permeable to gas and has a surface region which extends substantially in a plane, and
a sintered metal powder with which the substrate material is coated,
wherein the surface region is provided with alternating linear depressions and linear elevations, and
wherein a section of the surface region remains at least between two successive depressions or elevations.

15. The filter plate as claimed in claim 14, wherein the linear depressions and elevations extend in a wave form over the surface region.

16. The filter plate as claimed in claim 14, wherein the linear depressions and elevations extend diagonally over the surface region.

17. The filter plate as claimed in claim 14, wherein the linear depressions and elevations extend continuously over the surface region.

18. The filter plate as claimed in claim 14, wherein the linear depressions and elevations extend in a star shape over the surface region.

19. The filter plate as claimed in claim 14, wherein the linear depressions and elevations extend in a fishbone shape over the surface region.

20. The filter plate as claimed in claim 14, wherein edge of the surface region lies at the same level as the linear depressions or elevations.

21. The filter plate as claimed in claim 14, wherein the linear depressions are provided with additional punctiform depressions, and the linear elevations are provided with additional punctiform elevations.

22. The filter plate as claimed in claim 14, wherein a section of the surface region remains between each of the linear depressions and an adjacent linear elevation.

23. The filter plate as claimed in claim 14, wherein one of the linear depressions directly adjoins a linear elevation, and wherein a section of the surface region adjoins both the linear depression and the linear elevation.

24. The filter plate as claimed in claim 15, wherein the linear depressions and elevations extend continuously over the surface region.

25. The filter plate as claimed in claim 16, wherein the linear depressions and elevations extend continuously over the surface region.

26. The filter plate as claimed in claim 15, wherein edge of the surface region lies at the same level as the linear depressions or elevations.

27. The filter plate as claimed in claim 16, wherein edge of the surface region lies at the same level as the linear depressions or elevations.

28. The filter plate as claimed in claim 17, wherein edge of the surface region lies at the same level as the linear depressions or elevations.

29. The filter plate as claimed in claim 18, wherein edge of the surface region lies at the same level as the linear depressions or elevations.

30. The filter plate as claimed in claim 19, wherein edge of the surface region lies at the same level as the linear depressions or elevations.

31. A particulate filter for separating particulates out of an exhaust gas flow of an internal combustion engine, comprising a plurality of filter plates as claimed in claim 14 arranged substantially parallel to one another so as to alternately form inflow ducts and outflow ducts for the exhaust gas flow.

32. The particulate filter as claimed in claim 31, wherein two adjacent filter plates are designed so as to be mirror-symmetrical to one another.

33. The particulate filter as claimed in claim 32, wherein the depressions of the filter plates that form the inflow ducts take up a larger area than the elevations of the filter plates that form the inflow ducts.
